(19) United States
(12) Patent Application Publication
(10) Pub. No.: US 2003/0091843 A1
(43) Pub. Date: May 15, 2003

(54) Hydrolysis-resistant, transparent, amorphous film made from a crystallizable thermoplastic, and process for its production

(76) Inventors: Ursula Murschall, Nierstein (DE); Ulrich Kern, Ingelheim (DE); Guenther Crass, Taunusstein (DE)

Correspondence Address: ProPat, L.L.C., 2912 Crosby Road, Charlotte, NC, 28211-2815, US

(21) Appl. No.: 10/256,904

(22) Filed: Sep. 27, 2002

(30) Foreign Application Priority Data
Sep. 29, 2001 (DE) 101 48 306.6

(51) Int. Cl. B27N 7/00

(52) U.S. Cl. 428/480; 428/515; 264/504; 264/340

(57) ABSTRACT

The invention relates to a single- or multilayer, transparent, amorphous film which comprises at least one crystallizable thermoplastic as main constituent, in particular a polyester, and also comprises at least one hydrolysis stabilizer. The hydrolysis stabilizer is preferably a phenolic compound, an oxazoline, and/or a monomeric or polymeric carbodiimide, where appropriate combined with an organic phosphite. It is preferably added in the form of a masterbatch. On exposure to moisture and heat it shows practically no embrittlement and retains its tensile stress at break. The film may have been rendered UV-resistant, or flame-retardant, or one side or on both sides have been coated, or be sealable, and/or have been corona- or flame-treated. It is generally produced by extrusion or coextrusion, the hydrolysis stabilizer being added in the form of a predried or precrystallized masterbatch. The film can be shaped particularly effectively by thermoforming.

### BACKGROUND OF THE INVENTION

1. Field of the Invention

The invention relates to a single- or multilayer, transparent, amorphous film which comprises at least one crystallizable thermoplastic as main constituent. It further relates to the use of the film and to a process for its production.

2. Description of the Related Art

Transparent amorphous, and also semicrystalline, films made from crystallizable thermoplastics, in particular from crystallizable polyesters, are known and have been widely described. Functional films of this type are also known. The functionalization may be achieved by incorporating additives into the film. The additives increase their flame retardancy and/or their UV resistance, for example. It is also possible to coat the film or to modify its surface by chemical pretreatment, corona discharge or flame treatment, for example in order to make it sealable, printable, writeable, antistatic, metallizable, or sterilizable.

EP-A 620 245 discloses biaxially oriented polyester films which exhibit improved heat resistance. They comprise antioxidants which scavenge free radicals formed within the film, or degrade any peroxides formed. Free-radical scavengers disclosed are sterically hindered phenols, secondary aromatic amines, and sterically hindered amines, and peroxide degraders disclosed are compounds of trivalent phosphorus, in particular phosphonites or phosphites. However, the films generally have inadequate UV resistance.

DE-A 198 23 991 describes amorphous (=non-crystalline), non-oriented sheets of thickness from 0.1 to 20 mm which comprise a bibenzoyl-modified polyalkylene terephthalate and/or a bibenzoyl-modified polyalkylene naphthalate as main constituent. The sheets have particularly good properties over a wide temperature range. This means in particular that when Charpy impact strength aₙ is determined (determined to ISO 179/1D) no fracture occurs, and that Izod impact strength (ISO 180) at −40° C. is preferably in the range from 10 to 120 kJ/m². The sheets are produced with the aid of smoothing calenders, the amorphous condition being frozen in by rapid cooling of the polymers to a temperature below the glass transition temperature.

EP-A 035835 describes a biaxially oriented and heat-set polyester film having more than one layer, encompassing a layer made from a highly crystalline polyester and, bonded thereto, a sealable layer made from a substantively amorphous, linear polyester. The latter layer comprises finely distributed particles, the average diameter of the particles being greater than the thickness of the layer. These particles form surface protrusions which prevent undesirable blocking or adherence to rolls or guiding systems. The result is better winding and processing of the film. The sealing performance of the film is impaired by choosing particles whose diameter is greater than the thickness of the sealable layer, at the concentrations given in the examples. The seal seam strength of the sealed film at 140° C. is in the range from 63 to 120 N/m (0.97 N/15 mm to 1.8 N/15 mm of film width).

EP-A 432 886 describes a coextruded film with a polyester base layer, and with an outer layer made from a sealable polyester, and with a reverse-side polyacrylate coating. The sealable outer layer may be composed of a copolyester having units derived from isophthalic acid and terephthalic acid. The reverse-side coating gives the film improved processing performance. The seal seam strength is measured at 140° C. For a sealable layer of 11 μm thickness, the seal seam strength given is 761.5 N/m (11.4 N/15 mm). A disadvantage of the reverse-side acrylate coating is that this side no longer has sealability to the sealable outer layer. The uses of the film are therefore very restricted.

A coextruded, multilayer sealable polyester film is also described in EP-A 515 096. The sealable layer additionally comprises pigment particles, preferably silica gel particles. The particles may also be applied to the film after extrusion, for example by coating with an aqueous silica gel dispersion. This method is intended to give a film whose sealing properties have been retained and which processes well. The reverse side comprises only very few particles, most of which pass into this layer via the regrind. The seal seam strength is measured at 140° C. and is above 200 N/m (3 N/15 mm). The seal seam strength given for a sealable layer of 3 μm thickness is 275 N/m (4.125 N/15 mm).

WO 98/06575 discloses a coextruded multilayer polyester film encompassing a sealable outer layer and a non-sealable base layer. This base layer may have been built up from one or more layers, the interior layer being in contact with the sealable layer. The other (exterior) layer then forms the second, non-sealable outer layer. Here too, the sealable outer layer may be composed of copolyesters having units derived from isophthalic acid and terephthalic acid. However, no antiblocking particles are present in the outer layer. The film also comprises at least one UV absorber, present in a proportion of from 0.1 to 10% by weight in the base layer. The UV absorbers used in this instance are zinc oxide particles or titanium dioxide particles, in each case with an average diameter below 200 nm, but preferably triazines, (e.g. ®Tinuvin 1577 from Ciba). The base layer has conventional antiblocking agents. The film has good sealability, but not the desired processing performance, and also has shortcomings in its optical properties.

Layers made from copolyester can be produced by applying an appropriate aqueous dispersion. For example, EP-A 144 978 describes a polyester film which, on at least one side, has a continuous coating made from the copolyester. The dispersion is applied to the film prior to orientation or, respectively, prior to the final step of orientation. The polyester coating is composed of a condensation product of various monomers capable of forming polyesters, for example isophthalic acid, aliphatic dicarboxylic acids, sulfomonomers, and aliphatic or cycloaliphatic glycols.

DE-A 23 46 787 discloses, inter alia, flame-retardant films made from linear polyesters, modified with carboxyphosphinic acids. However, production of these films is attended by a variety of problems, for example, the raw material is very susceptible to hydrolysis and requires very thorough predrying. When the raw material is dried using prior art dryers it cakes, and production of a film is possible only under very difficult conditions. The films produced, under extreme and uneconomic conditions, also embrittle at high temperatures. The associated decline in mechanical properties is so severe as to make the film unusable. This embrittlement arises after as little as 48 hours at high temperatures.

However, all of the films mentioned generally have inadequate resistance to exposure to aqueous media, and they and the items produced from them are therefore unsuitable for applications where they come into contact with moisture or water. When this occurs, the impairment of mechanical properties is such as to make the films completely unusable. In addition, most of the known films are oriented and therefore semicrystalline.

### SUMMARY OF THE INVENTION

An object of the invention was therefore to provide a transparent, amorphous film which has good mechanical and optical properties, does not show embrittlement when exposed to heat, is cost-effective to produce, and is resistant to hydrolysis. A hydrolysis-resistant film is one whose impact strength is more than 100 mJ/mm² longitudinally and transversely (determined to DIN 53448) after 1 000 hours at 60° C. and 95% relative humidity in the heat/moisture test (long-term moisture test). The film should also be capable of problem-free thermoforming. This means that the film can be thermoformed on conventional thermoforming machinery without uneconomic predrying, to give complex and large-surface-area moldings.

It has now been found that this object can be achieved by incorporating at least one hydrolysis stabilizer. Surprisingly, the film does not lose any optical or mechanical properties.

The present invention therefore provides a single- or multilayer, transparent, amorphous film which comprises a crystallizable thermoplastic as main constituent, and comprises at least one hydrolysis stabilizer.

A first group of effective hydrolysis stabilizers is that of compounds which suppress or slow the hydrolysis ester bonds. Examples of these are phenolic stabilizers, in particular those whose molecular weight is above 500. They include sterically hindered phenols, thiobisphenols, alkylidene-bisphenols, alkylphenols, hydroxybenzyl compounds, acylaminophenols, and hydroxyphenyl propionate (in particular (3,5-di-tert-butyl-4-hydroxyphenyl)-propionates of pentaerythritol or 1-octadecanol, obtainable with the name ®Irganox from Ciba Specialty Chemicals). These compounds are described by way of example in the monograph “Kunststoffadditive” [Plastics additives] by Gächter and Müller, 2nd Edn., Carl Hanser Verlag. The proportion of the phenolic stabilizers is generally from 0.1 to 5.0% by weight, preferably from 0.2 to 3.0% by weight, based in each case on the weight of the film or of the layer provided therewith (in the case of the multilayer film).

The phenolic stabilizers mentioned are preferably combined with organic phosphites, in particular with triaryl phosphites (for example those obtainable with the name ®Irgafos 168 from Ciba Specialty Chemicals). These are capable of degrading peroxides and therefore act as secondary stabilizers. The ratio by weight of phenolic stabilizers to organic phosphites here is generally from 10:90 to 90:10. Mixtures of primary and secondary hydrolysis stabilizers are also commercially available, for example with the names ®Irganox B 561 or ®Irganox B 225.

A second group of effective hydrolysis stabilizers is that of compounds which can regenerate bonds previously broken by hydrolysis. Monomeric or polymeric carbodiimides, specifically dicyclohexylcarbodiimide or aromatic polymeric carbodiimides, are suitable for reinstating an ester bond, starting from a hydroxy group and a carboxy group, particularly suitable polymeric carbodiimides being those with a molecular weight of from 2 000 to 50 000 and with a melting range of from 60 to 210° C. (obtainable by way of example with the names ®Stabaxol P from Rhein Chemie GmbH, Mannheim, or P17 from Raschig GmbH, Ludwigshafen), other such compounds being oxa-zolines. The proportion of these compounds is generally from 0.1 to 5.0% by weight, preferably from 0.2 to 3.0% by weight, based in each case on the weight of the single-layer film or of the layer provided therewith in the multilayer film.

### DETAILED DESCRIPTION OF THE PREFERRED EMBODIMENTS

A preferred film of the invention comprises compounds which reduce hydrolysis rate and also compounds which can regenerate ester bonds. It is particularly resistant to moisture or water. In one preferred embodiment, the film therefore comprises from 0.1 to 5% by weight of polymeric aromatic carbodiimides and from 0.1 to 5% by weight of a blend of from 30 to 90% by weight of an organic phosphite (in particular a triaryl phosphite) and from 70 to 10% by weight of a hydroxyphenylpropionate.

The proportion of all of the hydrolysis stabilizers together is generally from 0.2 to 16.0% by weight, preferably from 0.5 to 14.0% by weight, based in each case on the weight of the film or of the relevant layer of the multilayer film.

Unlike UV stabilizers, the hydrolysis stabilizers exhibit practically no, or only relatively minor, absorption at a wavelength of from 380 to 400 nm.

The hydrolysis stabilizers make the film of the invention very resistant to moisture. This means that its tensile strength at break is more than 100 N/mm² longitudinally and transversely after 1 000 hours at 85° C. and 95% relative humidity in the heat/moisture test (long-term moisture test).

The good optical properties of the film include in particular high light transmittance L (determined to ASTM D1 003) of more than 80%, preferably more than 82%, and a low Yellowness Index YI (determined to DIN 6167) of less than 15, preferably less than 12, this being surprisingly good in view of the high hydrolysis resistance.

The film is also cost-effective to produce. For example, the raw materials or the raw material components needed to produce the film can be dried using conventional industrial dryers, such as vacuum dryers, fluidized-bed dryers, or fixed-bed dryers (tower dryers), and this does not cause the raw materials to cake or thermally degrade.

The film does not embrittle when exposed to heat. This means that the mechanical properties of the film are not significantly impaired even after 1 000 hours of heat-conditioning at 60° C. in a circulating-air oven. In contrast, these requirements are not complied with by amorphous polyethylene terephthalate films without hydrolysis stabilizers.

The film of the invention comprises a crystallizable thermoplastic as main constituent, in particular a crystallizable polyester or copolyester. Examples of suitable crystallizable or semicrystalline (co)polyesters are polyethylene terephthalate (PET), polyethylene naphthalate (PEN), polybutylene terephthalate (PBT), bibenzoyl-modified polyethylene terephthalate (PETBB), bibenzoyl-modified polybutylene terephthalate (PBTBB), and bibenzoyl-modified polyethylene naphthalate (PENBB), and mixtures of these, preference being given to polyethylene terephthalate (PET) and bibenzoyl-modified polyethylene terephthalate (PETBB).

For the purposes of the present invention, “crystallizable thermo-plastics” are crystallizable homopolymers, crystallizable copolymers, crystallizable compounded materials, crystallizable recycled material, or any other type of crystallizable thermoplastic.

Substances which may be used for preparing crystallizable, thermoplastic (co)polyesters, besides the main monomers, such as dimethyl terephthalate (DMT), ethylene glycol (EG), propylene glycol (PG), 1,4-butanediol, terephthalic acid (TA), benzenedicarboxylic acid, and/or naphthalene-2,6-dicarboxylicacid (NDA), are isophthalic acid (IPA) and/or cis-and/or trans-1,4-cyclohexanedimethanol (c-CHDM, t-CHDM, or c/t-CHDM).

The standard viscosity SV (DCA) of the polyethylene terephthalate is generally from 800 to 1 400, preferably from 900 to 1 300.

Preferred starting materials for producing the film of the invention are crystallizable thermoplastics with a crystalline melting point Tm of from 180 to 365° C. or above, preferably from 180 to 310° C., and with a crystallization temperature range Tc of from 75 to 280° C., and with a glass transition temperature Tg of from 65 to 130° C. (determined by differential scanning calorimetry (DSC) at a heating rate of 20° C./min) and with a density from 1.10 to 1.45 (determined to DIN 53479), and with a crystallinity of from 5 to 65%, preferably from 20 to 65%.

For the purposes of the present invention, amorphous films are those which are not crystalline despite the use of a crystallizable thermoplastic with a crystallinity of from 5 to 65%, preferably from 20 to 65%. Non-crystalline (=amorphous) means that the degree of crystallinity is below 3%, preferably below 1%. A film of this type is generally unoriented.

Films with particularly good thermoformability comprise crystallizable thermoplastics which have a proportion of from 1.0 to 12% by weight, preferably from 1.2 to 11% by weight, particularly preferably from 1.3 to 10% by weight, of diethylene glycol units and/or a proportion of from 1.0 to 12% by weight, preferably from 1.2 to 11% by weight, particularly preferably from 1.3 to 10% by weight, of polyethylene glycol units, and/or a proportion of from 3.0 to 10% by weight of isophthalic acid units.

The bulk density (determined to DIN 53466) is from 0.75 to 1.0 kg/dm³, preferably from 0.80 to 0.90 kg/dm³.

The polydispersity (=ratio of Mw to Mn) of the thermoplastic, measured by gel permeation chromatography (GPC) is preferably from 1.5 to 4.0, particularly preferably from 2.0 to 3.5.

“Main constituent” means that the proportion of the at least one semicrystalline (crystallizable) thermoplastic is preferably from 50 to 99% by weight, particularly preferably from 75 to 95% by weight, based in each case on the total weight of the film or, respectively, the total weight of the layer within the film. The remaining content may be made up by other conventional additives for biaxially oriented, transparent films, besides the hydrolysis stabilizer.

The thickness of the amorphous film of the invention is generally from 30 to 1 000 μm, preferably from 50 to 500 μm, particularly preferably from 75 to 300 μm. It may be single-layer or multilayer. In the multilayer embodiment, the film is composed of at least one core layer, at least one outer layer, and, where appropriate, at least one intermediate layer, and particular preference is given to a three-layer A-B-A or A-B-C structure. For this embodiment it is important that the standard viscosity of the polyethylene terephthalate of the core layer is similar to that of the polyethylene terephthalate of the outer layer(s) which is/are adjacent to the core layer.

In one particular embodiment, the outer layers and/or the intermediate layers of the multilayer film may also be composed of a polyethylene naphthalate homopolymer or of polyethylene terephthalate-polyethylene naphthalate copolymers, or of a compounded material. In this embodiment, the standard viscosities of the thermoplastics of the outer layers are again similar to that of the polyethylene terephthalate of the core layer.

In the multilayer embodiment, the hydrolysis stabilizer(s) is/are preferably present in the base layer. However, if required, the outer layers and/or any intermediate layers present may also have been provided with hydrolysis stabilizers in the concentration stated for the monofilm. Unlike in the single-layer embodiment, the concentration of the stabilizers here is based on the weight of the layer provided with the materials.

The film of the invention may be combined with another, single- or multilayer film to give a composite film. An example of the other film is a standard PET film or a polyolefin film, in particular a polyethylene or polypropylene film. It is also possible to combine two films of the invention. Where appropriate, the film of the invention is coated in advance, for example with an ethylene-vinyl alcohol copolymer (EVOH), a polyvinyl alcohol, or a polyvinylidene dichloride. Like the film of the invention, the other film may be amorphous, i.e. unoriented. It may also have a sealable layer. Its thickness is generally from 30 to 500 μm. There may, where appropriate, be a tie layer arranged between the individual films. It may be produced by applying an appropriate solution or dispersion, which may comprise water or an organic solvent. To produce a tie layer of weight from 1 to 10 g/m², the proportion of the adhesion promoter is advantageously from 5 to 40% by weight, based on the total weight of the coating solution. Particularly suitable adhesion promoters are adhesives which are composed of thermoplastic resins, such as cellulose esters, cellulose ethers, alkyl esters, acrylic esters, polyamides, polyurethanes, polyesters, hot-curing resins (in particular epoxy resins, urea-formaldehyde resins, phenol-formaldehyde resins, or melamine-formaldehyde resins), or synthetic rubbers. Suitable organic solvents for the coating solutions or coating dispersions are hydrocarbons (such ligroin and toluene), esters (such as ethyl acetate), or ketones (such as acetone or butanone).

The composite film may be produced by lamination. For this, the film is usually passed through rollers temperature-controlled at from 30 to 90° C. The other film may also be produced by in-line coating directly on the first film (melt extrusion onto an existing film).

The film of the invention may also comprise one or more optical brighteners. The proportion of brightener(s) is generally from 10 to 50 000 ppm, preferably from 20 to 30 000 ppm, particularly preferably from 50 to 25 000 ppm, based in each case on the weight of the crystallizable thermoplastic. The optical brightener is preferably fed in the form of a masterbatch directly during film production. It is capable of absorbing UV radiation in the wavelength region from 360 to 380 nm and of reemitting this in the form of longer-wavelength, visible, blue-violet light. Particularly suitable brighteners are benzoxazol derivatives, triazines, phenylcoumarins, and bisstyrylphenols, obtainable with the names ®Tinopal (Ciba Specialty Chemicals, Basel, Switzerland), ®Hostalux KS (Clariant GmbH, Germany), or ®Eastobrite OB-1 (Eastman, USA), for example.

Besides the optical brightener, blue dyes soluble in the thermoplastic may, where appropriate, also have been added. Suitable examples here are ultramarine blue and anthraquinone dyes, in particular Sudan Blue 2 (BASF AG, Ludwigshafen, Germany). The proportion of blue dye is generally from 10 to 10 000 ppm, preferably from 20 to 5 000 ppm, particularly preferably from 50 to 1 000 ppm, based in each case on the weight of the crystallizable thermoplastic.

The film of the invention can moreover be recycled without pollution of the environment, and film produced here from the recycled material exhibits practically no impairment of optical properties (in particular Yellowness Index) or mechanical properties in comparison with a film produced from virgin starting materials.

Base layer and/or outer layer(s) may also comprise besides the hydrolysis stabilizer(s) and the additives described above, other conventional additives, such as fillers and antiblocking agents. Examples of inorganic blocking agents are silicon dioxide, aluminum oxide, titanium dioxide, barium sulfate, calcium carbonate, and kaolin. The antiblocking agents are advantageously added to the polymer or polymer mixture before melting begins.

Other additives which may be selected are mixtures of two or more different antiblocking agents or mixtures of antiblocking agents of the same makeup but different particle size. The particles may be added to the individual layers in conventional proportions, e.g. in the form of a glycolic dispersion, during polycondensation, or by way of masterbatches during extrusion. Particularly suitable proportions of pigment have proven to be from 0.0001 to 10.0% by weight, based on the weight of the outer layers.

For particular applications it can be advantageous for the surface of the film to be chemically pretreated by treatment with acids. Those particularly suitable for this “adhesion edging” are trichloroacetic acid, dichloroacetic acid, and hydrofluoric acid. The surface is exposed to these for a short time (from to 120 seconds) and they are then removed, for example with what is known as an air knife. The resultant surface of the film is highly reactive and amorphous.

The film of the invention may have at least one other functionality. The additional functionality is preferably that the film has been rendered UV-resistant, or flame-retardant, or on one side or on both sides has been coated, or is sealable, and/or has been corona- or flame-treated.

One or both sides of the film of the invention may therefore have a coating. The thickness of the coating on the finished film is generally from 5 to 100 nm, preferably from 20 to 70 nm, in particular from 30 to 50 nm. It is preferably applied in-line, i.e. during the film-production process. Application by reverse gravure roll coating is particularly preferred, and this process permits extremely uniform application of the coating at the layer thickness mentioned. The coatings are applied—preferably by aqueous methods—as solutions, suspensions, or dispersions, and provide the film surface with additional functionalities of the type mentioned above. Examples of substances or compositions which provide additional functionality are acrylates (see WO 94/13476), ethylene-vinyl alcohols, PVDC, waterglass (Na₂SiO₄), hydrophilic polyesters (PET/IPA polyesters containing the sodium salt of 5-sulfoisophthalic acid, as mentioned in EP-A 144 878 or U.S. Pat. No. 4,252,885), copolymers having vinyl acetate units (see WO 94/13481), polyvinyl acetates, polyurethanes, the alkali metal or alkaline earth metal salts of C₁₀-C₁₈ fatty acids, copolymers having units derived from butadiene and acrylonitrile, methyl methacrylate, methacrylic acid, and/oracrylic acid, and/or esters of these. The substances or compositions which provide the additional functionality may comprise conventional additives, such as antiblocking agents and/or pH stabilizers, in amounts of from 0.05 to 5% by weight, preferably from 0.1 to 3% by weight, based on the substances or compositions which provide the additional functionality.

The compositions or substances mentioned are applied in the form of dilute, preferably aqueous solution, emulsion, or dispersion to one or both sides of the film. The solvent is then removed.

Vapor-deposition may have been used to apply in particular ethylene-vinyl alcohol copolymers, polyvinyl alcohol or polyvinylidene dichloride to one or both sides of the film.

The film of the invention may also have been made UV-resistant. Light, in particular the ultraviolet content of solar radiation, i.e. the wavelength region from 280 to 400 nm, causes degradation in thermoplastics, the results of which are not only a change in appearance due to color change or yellowing but also an extremely adverse effect on the mechanical and physical properties of films made from these thermoplastics. The suppression of this photooxidative degradation is of considerable industrial and economic importance, since without it many thermoplastics have drastically reduced scope of application. The absorption of UV light by polyethylene terephthalates, for example, start below 360 nm, increasing markedly below 320 nm, and is very pronounced below 300 nm. Maximum absorption occurs at between 280 and 300 nm. In the presence of oxygen it is mainly chain cleavage which is observed, but without any crosslinking. The predominant photooxidation products in quantity terms are carbon monoxide, carbon dioxide and carboxylic acids. Besides direct photolysis of the ester groups, attention has to be paid to oxidation reactions which proceed via peroxide radicals, again to form carbon dioxide. In photooxidation of polyethylene terephthalates there can also be cleavage of hydrogen at the position a to the ester groups, giving hydroperoxides and decomposition products of these, and this may be accompanied by chain cleavage (H. Day, D. M. Wiles, J. Appl. Polym. Sci. 16 [1972] p. 203).

UV stabilizers, i.e. light stabilizers which are UV absorbers, are chemical compounds which intervene in the physical and chemical processes of light-induced degradation. Carbon black and other pigments can give some protection from light, but these substances are unsuitable for transparent films, since they cause discoloration or color change. UV stabilizers which are suitable light stabilizers are those which absorb at least 70%, preferably at least 80%, particularly preferably at least 90%, of the UV light in the wavelength region from 180 to 380 nm, preferably from 280 to 350 nm. These are particularly suitable if they are thermally stable, i.e. do not decompose into cleavage products, nor cause any evolution of gas, in the temperature range from 260 to 300° C. Examples of UV stabilizers which are suitable light stabilizers are 2-hydroxybenzophenones, 2-hydroxybenzotriazoles, organo-nickel compounds, salicylic esters, cinnamic ester derivatives, resorcinol monobenzoates, oxanilides, hydroxybenzoic esters, benzoxazinones, sterically hindered amines and triazines, preference being given to the 2-hydroxybenzotriazoles, the benzoxazinones and the triazines. For the skilled worker it was highly surprising that the use of UV stabilizers in combination with hydrolysis stabilizers leads to useful films with excellent properties.

There are UV stabilizers known from the literature which absorb UV radiation and therefore provide protection. The skilled worker would then probably have used one of these known and commercially available UV stabilizers, but in doing this would have found that the UV stabilizer lacks thermal stability and evolves gases or decomposes at temperatures from 200 to 240° C. In order to prevent damage to the film, the skilled worker would have had to incorporate large amounts (from about 10 to 15% by weight) of UV stabilizer, so that the UV light is really effectively absorbed by the stabilizer. However, at these high concentrations the film yellows within just a short period after its production. Its mechanical properties are also adversely affected. In addition, stabilizer can deposit on the dies or rollers, leading to variations in profile or to impairment of optical properties (excessive haze, adhesion defects, non-uniform surface).

In one particularly preferred embodiment, the film of the invention comprises, as UV stabilizer, from 0.1 to 5.0% by weight of 2-(4,6-diphenyl-[1,3,5]-triazin-2-yl)-5-hexyloxyphenol of the formula

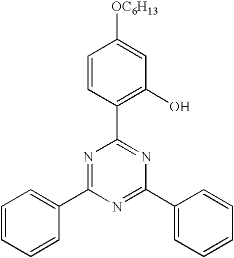

or from 0.1 to 5.0% by weight of 2,2′-methylenebis[6-benzotriazol-2-yl-4-(1,1,2,2-tetramethylpropyl)phenol] of the formula

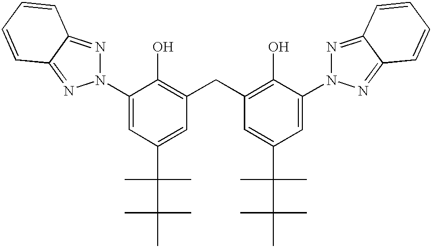

or from 0.1 to 5.0% by weight of 2,2′-(1,4-phenylene)bis([3,1]benzoxazin-4-one) of the formula

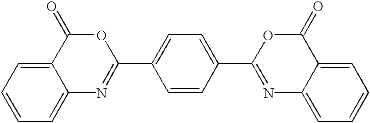

In another embodiment, it is also possible for mixtures of these UV stabilizers to be used, or mixtures of at least one of these UV stabilizers with other UV stabilizers, the total concentration of light stabilizers preferably being from 0.1 to 5.0% by weight, particularly preferably in the range from 0.5 to 3.0% by weight, based on the weight of the layer provided with the materials.

Surprisingly, even a small portion of the abovementioned UV stabilizers is sufficient to provide the film of the invention with excellent UV protection. The film of the invention has excellent optical properties, excellent profile, and excellent layflat. With this, it can be produced cost-effectively by a reliable process. It is moreover very surprising that it is even possible to reuse the regrind without any adverse effect on the Yellowness Index of the film. Nor is there any adverse effect within the limits of accuracy of measurement on the Yellowness Index of the film when comparison is made with a film not provided with the materials.

In another embodiment, the film of the invention has been made flame-retardant. For the purposes of the present invention, the term flame retardant implies that the film complies with the conditions of DIN 4102 Part 2, and in particular the conditions of DIN 4102 Part 1 in tests known as fire-protection tests, and can be assigned to construction materials class B2, and in particular B1, for low-flammability materials. When it is appropriate for the film to be flame-retardant, it should also pass the UL 94 “Burning Test for Flammability of Plastic Materials”, to the extent that it can be placed in class 94 VTM-0. In this case, the film comprises a flame retardant, which is fed directly by way of what is known as masterbatch technology during film production, the proportion of the flame retardant being in the range from 0.2 to 30.0% by weight, preferably from 0.5 to 25% by weight, particularly preferably from 1.0 to 20.0% by weight, based on the weight of the layer of the crystallizable thermoplast. The proportion of the flame retardant in the masterbatch is generally from 5 to 60% by weight, preferably from 10 to 50% by weight, based in each case on the total weight of the masterbatch. Examples of suitable flame retardants are bromine compounds, chloro-paraffins and other chlorine compounds, antimony trioxide, and alumina trihydrate. However, the halogen compounds have the disadvantage that halogen-containing byproducts can be produced. In particular, hydrogen halides are produced in the event of a fire. Another disadvantage is that films provided with these materials have low light resistance. Examples of other suitable flame retardants are organophosphorus compounds, such as carboxyphosphinic acids, anhydrides of these, and alkanephosphonates, the organophosphorus compound preferably being copolymerized into the PET chain. It is important that the organic phosphorus compound is soluble in the thermoplastic, since otherwise the optical properties required are not complied with.

Very surprisingly, fire-protection tests to DIN 4102 and the UL test have shown that in order to provide improved flame retardancy in a three-layer film it is entirely sufficient to provide flame retardants in the outer layers whose thickness is from 0.5 to 2 μm. If required, and if fire-protection requirements are stringent, the core layer may also have what is known as a base level of flame retardants.

Measurements have moreover shown that the flame-retardant film of the invention also does not embrittle on long-term exposure to heat (1 000 hours at 60° C.).

Where very good sealability is demanded, and where this property cannot be achieved by on-line coating, the film of the invention has a structure of at least three layers and then, in one particular embodiment, encompasses the base layer B, a sealable outer layer A, and an outer layer C, which may be sealable where appropriate. If the outer layer C is likewise sealable, the two outer layers are then preferably identical.

The sealable outer layer A applied by coextrusion to the base layer B has a structure based on polyester copolymers and essentially consists of copolyesters composed predominantly of isophthalic acid units, bibenzoyl carboxylic acid units, and terephthalic acid units, and of ethylene glycol units. The remaining monomer units derive from other aliphatic, cycloaliphatic, or aromatic diols and, respectively, dicarboxylic acids which may be present in the base layer. The preferred copolyesters providing the desired sealing properties are those built up from ethylene terephthalate units and ethylene isophthalate units, and from ethylene glycol units. The proportion of ethylene terephthalate is from 40 to 95 mol %, and the corresponding proportion of ethylene isophthalate is from 60 to 5 mol %. Preference is given to copolyesters in which the proportion of ethylene terephthalate is from 50 to 90 mol % and the corresponding proportion of ethylene isophthalate from 50 to 10 mol %, and a high level of preference is given to copolyesters in which the proportion of ethylene terephthalate is from 60 to 85 mol % and the corresponding proportion of ethylene isophthalate is from 40 to 15 mol %.

For the outer layer C which may, where appropriate, be sealable, and for any intermediate layers present it is possible in principle to use polymers which are identical with those used in the base layer.

The desired sealing properties and processing properties of the film of the invention are obtained by combining the properties of the copolyester used for the sealable outer layer with the topographies of the sealable outer layer A and of the outer layer C which may, where appropriate, be sealable. The minimum sealing temperature of 110° C. and the seal seam strength of at least 0.6 N/15 mm are achieved if the copolymers described in some detail above are used for the sealable outer layer A. The best sealing properties are obtained for the film if no other additives are used with the copolymer, in particular no inorganic or organic fillers. This gives the lowest minimum sealing temperature and the highest seal seam strengths, for a given copolyester.

However, it also gives poor film handling, since the surface of the sealable outer layer A is highly susceptible to blocking. The film is almost impossible to wind and is unsuitable for further processing on high-speed packaging machinery. To improve the handling of the film and its processability, it is necessary to modify the sealable outer layer A. This is best done with the aid of suitable antiblocking agents of selected size, these being added to the sealable layer at a certain concentration and specifically in such a way as firstly to minimize blocking and secondly to give no significant impairment of sealing properties.

There may, where appropriate, also be an intermediate layer located between the base layer and the outer layer(s). It may be composed of the polymers described for the base layer. In one particularly preferred embodiment, it is composed of the polyester used for the base layer. Besides the hydrolysis stabilizer(s), it may also comprise other conventional additives.

The thickness of the intermediate layer is generally greater than 0.3 μm, and is preferably in the range from 0.5 to 15 μm, in particular from 1.0 to 10 μm.

The thickness of the outer layer(s) is generally greater than 0.1 μm and, is preferably in the range from 0.2 to 5 μm, in particular from 0.2 to 4 μm, and the outer layer may be of identical or different thickness.

The total thickness of the polyester film of the invention may vary within wide limits and depends on the intended application. It is preferably from 1 to 500 μm, in particular from 5 to 350 μm, with preference from 100 to 300 μm, the proportion made up by the base layer preferably being from about 40 to 90% of the total thickness.

To obtain other desired properties, the film may also have been corona- or flame-treated. The manner of carrying out the treatment is generally such that the surface tension of the film is then generally above 45 mN/m.

The present invention also provides a process for producing the film, generally by an extrusion or coextrusion process, for example on an extrusion line. It has proven particularly advantageous to add the at least one hydrolysis stabilizer in the form of a predried or precrystallized masterbatch prior to extrusion or coextrusion. The proportion of hydrolysis stabilizer(s) in the masterbatch is generally from 5 to 50% by weight, preferably from 6 to 30% by weight, based in each case on the total weight of the masterbatch. The hydrolysis stabilizer(s) is/are dispersed in a carrier material. Carrier materials which may be used are the thermoplastic itself, e.g. polyethylene terephthalate, or else other polymers compatible with the thermoplastic.

In masterbatch technology it is preferable for the grain size and the bulk density of the masterbatches to be similar to the grain size and the bulk density of the thermoplastic, so that uniform distribution is achieved, resulting in uniform properties.

The polyester films of the invention may be produced by known processes from a polyester, where appropriate with other raw materials, at least one hydrolysis stabilizer, and also where appropriate other conventional additives (these latter in the usual amounts of from 0.1 to 30% by weight, based on the weight of the film) either in the form of a monofilm or else in the form of a multilayer—where appropriate, coextruded-film with identical or different surfaces. For example, one surface may comprise particles while the other does not, or all of the layers may comprise particles. One or both surfaces of the film may also be provided with a functional coating, using known processes.

Masterbatches comprising the hydrolysis stabilizer(s) should have been precrystallized or predried. The same applies to masterbatches which comprise flame retardants or UV stabilizer(s). This predrying includes gradual heating of the masterbatches at reduced pressure (from 20 to 80 mbar, preferably from 30 to 60 mbar, in particular from 40 to 50 mbar), and also agitation and, where appropriate, post-drying at a constant, elevated temperature (likewise at reduced pressure). The masterbatches are preferably charged batchwise at room temperature from a feed vessel, in the desired blend together with the polymers of the base layer and/or outer layers and, where appropriate, with other raw material components, into a vacuum dryer which in the course of the drying period or residence time, traverses a temperature profile of from 10 to 160° C., preferably from 20 to 150° C., in particular from 30 to 130° C. During the residence time of about 6 hours, preferably 5 hours, in particular 4 hours, the mixture of raw materials is agitated at from 10 to 70 rpm, preferably from 15 to 65 rpm, in particular from 20 to 60 rpm. The resultant precrystallized and, respectively, predried mixture of raw materials is post-dried in a downstream vessel, likewise evacuated, at from 90 to 180° C., preferably from 100 to 170° C., in particular from 110 to 160° C., for from 2 to 8 hours, preferably from 3 to 7 hours, in particular from 4 to 6 hours.

The polymers or the mixtures of raw materials are then fed to the extruder, or, for the production of multilayer film, to two or more extruders as required. Any foreign bodies or contamination present may be filtered out from the polymer melt prior to the extrusion process. The melt(s) is/are then extruded with the aid of a mono-die or a coextrusion die to give a flat melt film or, respectively, two or more flat melt films laminated to one another. The single- or multilayer film is then quenched on a chill roll and solidified to give a substantially amorphous, i.e. unoriented film. The film is then trimmed and wound.

It was surprising that a film with hydrolysis resistance and heat resistance and with the property profile required could be produced without any technical problems (such as caking in the dryer) by using masterbatch technology combined with suitable predrying and/or precrystallization and the use of hydrolysis stabilizers.

It was also unexpected that even the flame-retardant embodiment of the film of the invention passes the heat/moisture test and does not embrittle.

Weathering tests have shown that even after from about 5 to 7 years of outdoor use the UV-resistant embodiment of the film of the invention shows practically no yellowing or embrittlement, no loss of gloss, and no surface cracking, and no impairment of mechanical properties.

The combination of properties of the film of the invention makes it suitable for a wide variety of different applications, for example indoors or outdoors, in the construction sector, or in the construction of exhibition stands, in the fitting out of shops or of stores, in the electronics sector, or in the lighting sector, for greenhouses, for interior decorations, for exhibition requisites or promotional requisites, as displays, for placards, for illuminated advertising profiles, for safety glazing of machinery or of vehicles, for a laminating medium, for credit cards or customer cards, or else in the refrigerator and freezer sector, as a composite film, or as a furniture film, in particular in the thermoforming sector or in the automotive sector.

The thermoforming process generally comprises the steps of predrying, heating, molding, cooling, demolding, and heat-conditioning. Surprisingly, the films of the invention can be thermoformed by this process even without predrying. The film may therefore also be in the form of a roll when fed to the thermoforming process. This is a substantial, and in particular economic, advantage over thermoformable polycarbonate or polymethyl methacrylate films. Depending on their thickness, these need predrying times of from 10 to 15 hours at temperatures of from 100 to 120° C. Surprisingly, details were also precisely reproduced on moldings produced with the film of the invention.

For thermoforming a film of the invention it has proven particularly advantageous for the temperature of the mold to be from 100 to 140° C., the heating time to be less than 5 seconds per 10 μm of film thickness, and for the film temperature during molding to be in the range from 100 to 160° C. The orientation factor is generally from 1.5 to 4.0, and the shrinkage less than 1.5%.

Due to their good UV resistance, flame retardancy, and low-temperature resistance, appropriately functionalized films of the invention are also suitable for outdoor applications, for example for greenhouses, roofing systems, protective coverings, external cladding, applications in the construction sector, in the refrigeration or deep-freeze sector, for illuminated advertising profiles, and also for credit cards, telephone cards, or other customer cards.

Examples are used below to provide further explanation of the invention, without restricting the same. Film properties were tested as follows:

Heat/Moisture Test (Long-Term Moisture Test)

In this test, the film was aged in an autoclave for 1 000 h at 60° C. and 95% relative humidity at atmospheric pressure. After ageing, impact strength is determined longitudinally and transversely to DIN 53448. It has to be more than 100 mJ/mm² if requirements are to be met.

High-Temperature Resistance

High-temperature resistance is determined after 1 000 h of heat-conditioning at 60° C. in a circulating-air drying cabinet. After this heat-conditioning, the impact strength to DIN 53448 has to be more than 100 mJ/mm² if requirements are to be complied with.

DEG Content, PEG Content, and PA Content

DEG content, PEG content, and PA content are determined by gas chromatography after saponification using methanolic KOH and neutralization using aqueous hydrochloric acid.

Light Transmittance (Transparency)

Light transmittance is the ratio of total transmitted light to the quantity of incident light. Light transmittance was determined using ®HAZEGARD plus test equipment from Byk Gardener, Germany, to ASTM D1003.

Yellowness Index

Yellowness Index (YI) is the deviation from colorlessness in the “yellow” direction, and was measured to DIN 6167. Yellowness Indices (Yls) below 6 are not detectable by the naked eye.

Surface Defects

Surface defects were determined visually.

Standard Viscosity (SV) and Intrinsic Viscosity (IV)

Taking DIN 53726 as a basis, standard viscosity SV was measured from a 1% strength solution in dichloroacetic acid (DCA) at 25° C. SV (DCA) =(ηᵣₑₗ−1)×1 000. Intrinsic viscosity (IV) is calculated as follows from standard viscosity (SV): IV=[η]=6.907·10⁻⁴ SV (DCA)+0.063096 [dl/g].

Weathering (Bilateral), UV Resistance

UV resistance was tested as follows to the ISO 4892 test specification:

| | |
|---|---|
| Test equipment | Atlas Ci65 Weather-Ometer |
| Test conditions | to ISO 4892, i.e. artificial weathering |
| Irradiation time | 1 000 hours (per side) |
| Irradiation | 0.5 W/m², 340 nm |
| Temperature | 63° C. |
| Relative Humidity | 50% |
| Xenon lamp | internal and external filter made from borosilicate |
| Irradiation cycles | 102 minutes of UV light, then 18 minutes of UV |
| | light with water spray on the specimens, then again |
| | 102 minutes of UV light, etc. |

Fire Performance

Fire performance was determined to DIN 4102, Part 2, construction materials class B2 and to DIN 4102 Part 1, construction materials class B1, and also the UL 94 test.

Determination of Minimum Sealing Temperature

Hot-sealed specimens (sealed seam 20 mm×100 mm) were produced using Brugger HSG/ET sealing equipment, by sealing the film at different temperatures with the aid of two heated sealing jaws at a sealing pressure of 2 bar and with a sealing time of 0.5 s. From the sealed specimens, test strips of 15 mm width were cut. The T-seal seam strength was measured as in the determination of seal seam strength. The minimum sealing temperature is the temperature at which a seal seam strength of at least 0.5 N/mm² is achieved.

Seal Seam Strength

To determine seal seam strength, two film strips of width 15 mm were placed one on top of the other and sealed at 130° C. with a sealing time of 0.5 s and a sealing pressure of 2 bar (apparatus: Brugger model NDS, single-side-heated sealing jaw). The seal seam strength was determined by the T-peel method.

### EXAMPLES

The examples and comparative examples below in each case concern transparent single- or multilayer films of varying thickness, produced on an extrusion line. Unless otherwise stated, percentages are percentages by weight.

The polyethylene terephthalate (clear polymer) from which the transparent film was produced had standard viscosity SV (DCA) of 1 110, corresponding to intrinsic viscosity IV (DCA) of 0.83 dl/g (polyethylene terephthalate T94 V from KoSa, Germany).

The additives for achieving hydrolysis protection and for achieving additional functionalities were fed in the form of various masterbatches:

| | |
|---|---|
| Masterbatch MB1: | |
| 6% by weight | of a phenolic hydrolysis stabilizer (® Irganox B561, |
| | a blend made from 80% by weight of Irgafos ® 168 |
| | and 20% by weight of ® Irganox 1010; Ciba |
| | Specialty Chemicals, Basle, Switzerland), |
| 94% by weight | of polyethylene terephthalate (hereinafter termed |
| | PET) |
| bulk density: | 750 kg/m³ |
| Masterbatch MB2: | |
| 20% by weight | of an aromatic polymeric carbodiimide (® Stabaxol |
| | P from Rhein Chemie, Mannheim, Germany), |
| 80% by weight | of PET |
| bulk density: | 750 kg/m³ |

The following masterbatch was used to produce UV-resistant films:

Masterbatch MB3:

| | |
|---|---|
| 20% by weight | of 2-(4,6-diphenyl-[1,3,5]triazin-2-yl)-5-hexyloxy- |
| | phenol (® Tinuvin 1577 from Ciba Specialty |
| | Chemicals) and |
| 80% by weight | of PET |

The following masterbatch was used to improve slip properties:

Masterbatch MB4:

Comprised 10 000 ppm of ®Sylobloc 44H (Grace, Germany) alongside PET.

The following masterbatch was used to produce a flame-retardant film:

Masterbatch MB5:

| | |
|---|---|
| 25% by weight | of bis(5-ethyl-2-methyl-2-oxo-2λ5-[1,3,2]dioxa- |
| | phosphinan-5-ylmethyl methane phosphonate) |
| | (® Amgard P1045 from Albright & Wilson |
| | Americas, USA), and |
| 75% by weight | of PET |

### Example 1

A transparent, amorphous monofilm of 150 μm thickness was produced and comprised 51% of PET, 10% of MB2 (the film correspondingly comprising 2% of hydrolysis stabilizer), and also 4% MB4 as antiblocking agent. The film also comprised 35% of directly arising regrind.

The mixture of the individual components was charged at room temperature from separate feed vessels to a vacuum dryer which traversed a temperature profile of from 25 to 130° C. from the time of charging to the end of the residence time. During the residence time of about 4 hours, the raw material mixture was stirred at 61 revolutions per minute.

The precrystallized or predried raw material mixture was post-dried for 4 hours in the downstream hopper at 140° C., again in vacuo. The mixture of raw materials was then fed to extruders where it was melted and then extruded to give the film described.

### Example 2

As described in Example 1, a monofilm of thickness 150 μm was produced. Unlike Example 1, the film also comprised 2% of MB1 alongside the PET (T94 V), the 10% of MB2, and the 4% of MB4.

### Example 3

Example 1 was repeated except that the film was now coated on both sides. For this, the film was coated on both sides, after extrusion, with the aid of a reverse gravure-roll coating process and an aqueous dispersion. The dispersion comprised water and

| | |
|---|---|
| 4.2% | of a hydrophilic polyester (PET/IPA polyester containing the |
| | sodium salt of 5-sulfoisophthalic acid, SP41 from Ticona, USA), |
| 0.15% | of colloidal silicon dioxide (® Nalco 1060 from Deutsche Nalco |
| | Chemie), and |
| 0.15% | of ammonium carbonate as pH buffer. |

The wet application weight was 1 g/m² per side. The calculated thickness of the dried coating was 80 nm.

### Example 4

Coextrusion was used to produce a hydrolysis-resistant and UV-resistant three-layer PET film of thickness 150 μm, with the layer sequence A-B-A, B being the core layer and A the outer layers. The thickness of the core layer was 145 μm, and that of each of the two outer layers was 2.5 μm.

The core layer was produced from a mixture made from 52% of PET (T94 V), 10% of MB2, 3% of MB3, and also 35% of directly arising regrind. For the outer layers use was made of a mixture made from 93% of PET (T94 V) and 7% of MB4.

### Example 5

Coextrusion was used to produce a sealable film of thickness 400 μm with the layer sequence A-B-C, the base layer B having a thickness of 396 μm while the thickness of each of the outer layers A and C was 2 μm.

For the base layer B use was made of a mixture made from 55% of PET (T94 V), 10% of MB2, and 35% of directly arising regrind.

For the sealable outer layer A, the thermoplastic used comprised a copolyester made from 78 mol % of ethylene terephthalate and 22 mol % of ethylene isophthalate (prepared by transesterification in the presence of a manganese catalyst-Mn concentration: 100 ppm). The outer layer comprised 3% of MB4 as antiblocking agent, alongside the thermoplastic.

For the non-sealable outer layer C use was made of a mixture made from 93% of PET (T94 V) and 7% of MB4.

### Example 6

As described in Example 5, an amorphous, hydrolysis-resistant, sealable film of 400 μm thickness was produced with the layer sequence A-B-C. Unlike in Example 5, the non-sealable outer layer C was coated, after extrusion, by “reverse gravure-roll coating” using an aqueous dispersion of the makeup mentioned in Example 3. The wet application weight was 1 g/m². The calculated thickness of the dry coating was 80 nm.

### Example 7

As described in Example 1, a monofilm of thickness 150 μm was produced. Unlike in Example 1, the film also comprised 3% of MB5.

### Example 8

As described in Example 1, a monofilm of thickness 150 μm was produced. Unlike in Example 1, the film also comprised 3% of MB5 and 3% of MB3.

### Example 9

As described in Example 4, a hydrolysis- and UV-resistant film of 150 μm thickness was produced with the layer sequence A-B-A. The film was then corona-treated on one side. The surface tension of the film was 48 mN/m after the treatment.

### Comparative Example 1

As described in Example 7, a monofilm of thickness 150 μm was produced, the only change being that no hydrolysis stabilizer was present in the film.

### Comparative Example 2

Comparative Example 1 was repeated but this time the flame retardant was also omitted.

The properties of the films produced as in the examples are given in the table below.

| | | E1 | E2 | E3 | E4 | E5 | E6 | E7 | E8 | E9 | CE1 | CE2 |
|---|---|---|---|---|---|---|---|---|---|---|---|---|
| Light | % | 93 | 94 | 93 | 96 | 95 | 95 | 93 | 92 | 97 | 93 | 94 |
| transmittance/ | | | | | | | | | | | | |
| transparency | | | | | | | | | | | | |
| Yellowness Index | | 1.8 | 1.9 | 1.7 | 1.9 | 2.2 | 2.1 | 1.9 | 2.0 | 1.9 | 1.9 | 1.8 |
| (YI) | | | | | | | | | | | | |
| Heat/moisture | | yes | yes | yes | yes | yes | yes | yes | yes | yes | no | no |
| test passed? | | | | | | | | | | | | |
| Heat-resistant? | | yes | yes | yes | yes | yes | yes | yes | yes | yes | no | no |
| UV resistance | nm | <380 | <380 | <380 | <290 | <380 | <380 | <380 | <290 | <290 | <380 | <380 |
| (absorption) | | | | | | | | | | | | |
| Flame retardancy | | | | | | | | B1, B2, | B1, B2, | | B1, B2, | |
| (fire class.) | | | | | | | | UL | UL | | UL | |
| Minimum sealing | A/A* | | | | | 125 | 124 | | | | | |
| temperature | ° C. | | | | | | | | | | | |
| Seal seam | A/A* | | | | | 0.8 | 0.9 | | | | | |
| strength | N/15 mm | | | | | | | | | | | |
| Surface tension | mN/m | 40 | 40 | 40 | 40 | 40 | 40 | 40 | 40 | 48 | 40 | 40 |
| Thickness | μm | 150 | 150 | 150 | 150 | 400 | 400 | 150 | 150 | 150 | 150 | 150 |
| Layer sequence | | B | B | B | ABA | ABC | ABC | B | B | ABA | B | B |
| Coating | | | | ++ | | | ++ | | | | | |
| (adhesion) | | | | | | | | | | | | |

*on sealing of outer layer A against outer layer A
++ better adhesion provided

Additional advantages, features and modifications will readily occur to those skilled in the art. Therefore, the invention in its broader aspects is not limited to the specific details, and representative devices, shown and described herein. Accordingly, various modifications may be made without departing from the spirit or scope of the general inventive concept as defined bye the appended claims and their equivalents.

The priority document, German Patent Application No. 101 48 306.6, filed Sep. 29, 2001 is incorporated herein by reference in its entirety. 10

As used herein and in the following claims, articles such as “the”, “a” and “an” can connote the singular or plural.

All documents referred to herein are specifically incorporated herein by reference in their entireties.

We claim:

1. A single- or multilayer, transparent, amorphous film which comprises at least one crystallizable thermoplastic as main constituent, and which comprises at least one hydrolysis stabilizer.

2. The film as claimed in claim 1, wherein the hydrolysis stabilizer is a phenolic compound.

3. The film as claimed in claim 1, wherein the hydrolysis stabilizer is a sterically hindered phenol, thiobisphenol, alkylidenebisphenol, alkyl-phenol, hydroxybenzyl compound, acylaminophenol, and/or hydroxyphenyl-propionate.

4. The film as claimed in claim 2, wherein the proportion of the phenolic compound is from 0.1 to 8.0% by weight based on the weight of the film or, if appropriate, of the layer provided therewith in the multilayer film.

5. The film as claimed in claim 2, wherein the phenolic compound has been combined with at least one organic phosphite.

6. The film as claimed in claim 5, wherein the organic phosphite is a triaryl phosphite.

7. The film as claimed in claim 5, wherein the ratio by weight of the phenolic compound to the organic phosphite is from 10:90 to 90:10.

8. The film as claimed in claim 1, wherein the hydrolysis stabilizer is a monomeric or polymeric carbodiimide and/or an oxazoline.

9. The film as claimed in claim 8, wherein the polymeric carbodiimide has a molecular weight of from 2 000 to 50 000.

10. The film as claimed in claim 8, wherein the proportion of the monomeric or polymeric carbodiimide and/or of the oxazoline is from 0.1 to 5.0% by weight, based on the weight of the monolayer film or, if appropriate, of the layer provided therewith in the multilayer film.

11. The film as claimed in claim 1, wherein the hydrolysis stabilizer is a mixture of from 0.1 to 5% by weight of polymeric aromatic carbodiimides and from 0.1 to 5% by weight of a blend of from 30 to 90% by weight of an organic phosphite and from 70 to 10% by weight of a hydroxy-phenylpropionate.

12. The film as claimed in claim 11, wherein the total proportion of all the hydrolysis stabilizers is from 0.2 to 16.0% by weight, based on the weight of the film or, if appropriate, of the relevant layer of the multilayer film.

13. The film as claimed in claim 1, wherein the crystallizable thermoplastic has a proportion of from 1.0 to 12% by weight of diethylene glycol units, and/or a proportion of from 1.0 to 12% by weight of polyethylene glycol units, and/or a proportion of from 3.0 to 10% by weight of isophthalic acid units.

14. The film as claimed in claim 1, which has been rendered UV-resistant, and/or flame-retardant and/or on one side or on both sides has been coated, and/or is sealable, and/or has been corona- or flame-treated.

15. The film as claimed in claim 14, wherein the film or at least one layer therein comprises a UV stabilizer.

16. The film as claimed in claim 15, wherein the UV stabilizer is selected from the group of 2-hydroxybenzophenones, 2-hydroxybenzotriazoles, organonickel compounds, salicylic esters, cinnamic ester derivatives, resorcinol monobenzoates, oxanilides, hydroxybenzoic esters, benzoxazinones, sterically hindered amines and triazines.

17. The film as claimed in claim 15, wherein the UV stabilizer is 2-(4,6-diphenyl[1,3,5]triazin-2-yl)-5-hexyloxyphenol, 2,2′-methylenebis[6-benzotriazol-2-yl-4-(1,1,2,2-tetramethylpropyl)phenol] or 2,2′-(1,4-phenylene)-bis[[3, 1]benzoxazin-4-one].

18. The film as claimed in claim 17, wherein the proportion of the UV stabilizer is from 0.1 to 5.0% by weight, preferably from 0.5 to 3.0% by weight, based on the total weight of the at least one layer.

19. The film as claimed in claim 14, wherein the film or at least one layer therein comprises a flame retardant.

20. The film as claimed in claim 19, wherein the flame retardant is a bromine compound, a chloroparaffin, or any other chlorine compound, antimony trioxide, aluminum hydroxide, or an organic phosphorus compound.

21. The film as claimed in claim 19, wherein the proportion of the flame retardant is from 0.5 to 30.0% by weight based on the weight of the layer of the crystallizable thermoplastic.

22. The film as claimed in claim 14, which also encompasses a sealable outer layer.

23. The film as claimed in claim 1, which has been combined with at least one other, single- or multilayer film, to give a composite film.

24. A process for producing the film as claimed in claim 1, which comprises melting, in an extruder, a mixture which encompasses at least one crystallizable thermoplastic as main constituent and encompasses at least one hydrolysis stabilizer, and using extrusion or coextrusion to mold the mixture to give a single- or multilayer film, at least one hydrolysis stabilizer being added in the form of precrystallized or predried masterbatch prior to extrusion or coextrusion.

25. The process as claimed in claim 21, wherein the film produced by extrusion or coextrusion is quenched with the aid of a chill roll.
